(19) United States
(12) Patent Application Publication
(10) Pub. No.: US 2002/0077801 A1
(43) Pub. Date: Jun. 20, 2002

(54) Facilited remote console and terminal emulator

(75) Inventors: Graham A. Morehead, Cambridge, MA (US); Armen Y. Skenderian, Danvers, MA (US); Harris L. Gilliam, Somerville, MA (US)

Correspondence Address: LOCKE LIDDELL & SAPP LLP, 600 TRAVIS, 3400 CHASE TOWER, HOUSTON, TX, 77002-3095, US

(73) Assignee: SuperWings, Inc.

(21) Appl. No.: 09/995,473

(22) Filed: Nov. 28, 2001

Related U.S. Application Data
(60) Provisional application No. 60/301,414, filed on Jun. 29, 2001.
(60) Provisional application No. 60/314,311, filed on Aug. 24, 2001.

(51) Int. Cl. G06F 9/455

(52) U.S. Cl. 703/24

(57) ABSTRACT

A system and method of use a facilitated remote console and terminal emulator that enables a machines to interact with and control another device as if the machine were a keyboard and monitor augmented with menus and shortcuts. This system includes the Client component and the Server component. Among these there are a number of variations that are necessary for different uses of the invention, including some variations that do not require the Server. The Client component makes the user interactive intuitive and efficient with the use of menus, drop-down lists, and shortcuts. This component can also comprise an instant messaging client. The Server component would then comprise a transport layer to connect the Client to a third party, a messaging server, and systems monitoring tools. In one embodiment this utilizes at least one wireless connection to increase efficiency and ease use.

This application claims relies upon U.S. Provisional Application Ser. No. 60/301,414, filed on Jun. 29, 2001 and U.S. Provisional Application Ser. No. 60/314,311, filed on Aug. 24, 2001.

### FIELD OF THE INVENTION

This invention pertains to the field of Service, Installation, and Maintenance. This invention would be used to install, upgrade, service, and diagnose computers, including but not limited to servers, embedded systems, and any machine equipped with a Command Line Interfaces port.

### BACKGROUND OF THE INVENTION

Computers are used in virtually every environment. Computers are located in obvious locations such as on our desks and in air-conditioned server rooms. The non-obvious ones are in our cars and in our home appliances. All of these computers require maintenance. Interaction with each of these computers can prove to be difficult.

For example, auto mechanics pay many thousands of dollars for the machine that they use to interact with a car's onboard computer. When a number of servers are employed together, they are often standalone, meaning that they have neither monitors nor keyboards attached. If a technician must service, upgrade, diagnose, or otherwise interact with one of these servers it must be done either from a remotely connected terminal, or he/she must carry a terminal to connect directly to the server. Typically this terminal consists of a laptop and a serial cable. The laptop connects directly to the server and software on the laptop emulates a remote console. The main weakness of this solution is cost.

Many companies spend in excess of $4,000.00 equipping their technicians with a laptop and a two-way pager or other such communication device. The most expensive part is obviously the laptop, but the work it accomplishes is not complex. The abilities of the laptop are so above this task as to make its usage in this capacity quite inefficient. Whether the processor is in your home appliance or a corporate web server, the need for more inexpensive maintenance tools exists.

Another impetus for the development of this invention is human error and imperfection. When interacting with a command line interface, the user or engineer must have mastery of a large vocabulary of commands and input methods. Engineers have difficulty remembering all of the commands that are may be used. Moreover, the user may not always have access to manuals or online “man” pages. Therefore, a need exists for the user to have access to many of these commands through menus or drop-down lists. This solution would save time and the mistakes found in the art.

Command Line Interfaces (CLI) are very inconvenient is comparison to graphical user interfaces such as a Windows®-type environment. They are, however, more stable. Therefore a need exists for the stable, simpler CLI but with common functionalities available at the click of a button, and some graphical interfaces where appropriate.

### SUMMARY OF THE INVENTION

A system and method of use of a facilitated remote console and terminal emulator that enables a machine to interact with and control another device as if the machine were a keyboard and monitor augmented with menus and shortcuts. This system includes the Client component and the Server component. Among these there are a number of variations that are necessary for different uses of the invention, including some variations that do not require the Server. The Client component makes the user interaction intuitive and efficient with the use of menus, drop-down lists, and shortcuts. This component can also comprise an instant messaging client. The Server component would then comprise a transport layer to connect the Client to a third party, a messaging server, and systems monitoring tools. In one embodiment this utilizes at least one wireless connection to increase efficiency and ease use.

The present invention provides for a system and method for using a computer to emulate a remote console for connection to a target device, wherein the computer has an output screen and wherein the target device has a serial port and a target device platform, the method which comprises the steps of: opening a connection through a wire to the serial port on the target device; automatically recognizing the target device platform; building menus, drop-down lists, or shortcuts according to the target device; entering commands on the computer; entering commands on the computer via the menus or the shortcuts; sending commands to the target device via the serial port; receiving output from the target device; displaying the output on the output screen; and running an instant messaging client in parallel wherein the target device does not distinguish the computer from a remote console. In preferred methods, target device is a server, the target device comprises a command line interface port, the target device is an embedded system (such as a vending machine, an automobile, medical equipment, a cable box, a security system, a home monitoring system, an entertainment equipment, or a home appliance), and/or the computer is a handheld computer. It is important to note that the commands and the output may be in ASCII format, or when the remote console is a full function terminal, the commands and the output may be in ANSI format. In some embodiments, the target device may include a command line interface port and the command line interface is selected from the group consisting of DOS prompt, korn shell, sh, bash, tcsh, prom monitor, VT100. In a most preferred method, a full functioning standard terminal editors such as vi and emacs is enabled.

In another embodiment, the present invention provides for a system and method for using a computer to emulate a remote console for connection via a server to a target device, wherein the computer has an output screen and a wireless modem and wherein the target device has a serial port and a target device platform, the method which comprises the steps of: opening a virtual socket to the server through the wireless modem; opening a connection between the server and the target device; automatically recognizing the target device platform; building menus, drop-down lists, or shortcuts according to the target device; entering commands on the computer; entering commands on the computer via the menus or the shortcuts; transporting the commands to the target device via virtual socket and the server; receiving output from the device via the virtual socket and the server; displaying the output on the screen of the computer; running an instant messaging client in parallel; wherein the target device does not distinguish the computer from a remote console. This method can use telnet, secured shell ssh, ssh2, or ssh3, or file transfer protocol while the commands are typically Unix, OS, or prom monitor commands and also allows for the use of a virtual private network. In a preferred embodiment, the target device may include a hub, a router, a switch, a bridge, a repeater, a gateway, a firewall, interactive television hardware, a manufacturing hardware, a robotics, or an animatronics.

The invention also includes providing a server system capable of connecting to computer emulating remote consoles for connection to target devices, the method which comprises the steps of: hosting a database of settings, wherein settings comprises alarm thresholds and preferences regarding monitoring, connection, or messaging; providing each connected computer with a user interface to modify settings; enforcing security on all activities by passwords, certificates, or hardware identification; pinging any targeted device; monitoring all targeted devices according to a specification or service level agreement; monitoring network congestion; providing an instant update on all monitored systems and/or network congestion upon request; firing alarms when a parameter reaches an adjustable threshold; diagnosing target device problems and inefficiencies; hosting interactive troubleshooting programs along with Frequently Asked Questions and Online Help applications; and running an instant messaging server in parallel to other processes; wherein the server is capable of maintaining and initiating multiple connections. In a preferred method, the computers are emulating different types of remote consoles and the system can process in parallel.

### BRIEF DESCRIPTION OF THE DRAWINGS

A more particular description of the invention, briefly summarized above, may be had by reference to the embodiments thereof, which are illustrated in the appended drawings and described herein. It is to be noted, however, that the appended drawings illustrate only some embodiments of the invention and are therefore not to be considered limiting of its scope, because the invention may admit to other equally effective embodiments.

FIG. 1 is a diagram of an embodiment of the invention;

FIG. 2 is a diagram of an embodiment of the invention; and

FIG. 3 is a diagram of an embodiment of the invention showing a preferred method of use.

### DETAILED DESCRIPTION OF THE PREFERRED EMBODIMENT

The following terms and acronyms are used herein:

ANSI—Acronym for the American National Standards Institute

ANSI Terminal—standardized protocol for a terminal program as defined by ANSI

ASCII—acronym for the American Standard Code for Information Interchange

ASCII format—a code defined by ASCII for representing English characters as numbers, with each letter assigned a number from 0 to 127

CLI—acronym for Command Line Interface, refers to the simplest UI, a purely text based one.

Device—a general term used within the scope of this invention to refer to any computer or processor with which interaction is desired

emacs—a commonly used file editor that requires escape sequences

Embedded System—a specialized chip or processor that is part of a larger system or machine

FAQ—acronym for Frequently Asked Questions

Computer—a general term used within the scope of this invention to refer to preferably a small computing device such as computers, portable computers, handheld portable computers, palm-top portable computers, personal computers, palm-size personal computers, personal computer notebooks, handheld organizers, personal digital assistants, laptops, and similar devices such as the preferred devices such as the Palm® device or a PocketPC™ device.

Online Help—a general term referring to online manuals, troubleshooting programs that lead a user through a number of steps, and other resources remotely obtainable

Server—a general term used within the scope of this invention to refer to a computer, typically a powerful one

UI—acronym for User Interface, refers to what the user sees and how the user enters information

vi—another commonly used file editor that requires escape sequences

The main two components of the invention are the Client component and the Server component. Among these there are a number of variations that are necessary for different uses of the invention, including some variations that do not require the Server. The Client component makes the user interaction intuitive and efficient with the use of menus, drop-down lists, and shortcuts. This component can also comprise an instant messaging client. The Server component would then comprise a transport layer to connect the Client to a third party, a messaging server, and systems monitoring tools.

In the following portion of the description and without limiting the scope of any of these terms, the term “Computer” refers to the machine used as a client, “Device” refers to the machine targeted for connection, “Server” refers to the machine used to run monitoring tools, a messaging server, and to connect the Computer to the Device. “RC” will be taken to mean “Remote Console,” and “TE” will be taken to mean “Terminal Emulator.”

Though those skilled in the art will recognize that the teachings and scope of this invention are not limited to the following, this disclosure provides some of the preferred embodiments of the invention. For example, the following provides a preferred embodiment having a remote console connected via a serial port such an asynchronous port referred to as a COM port.

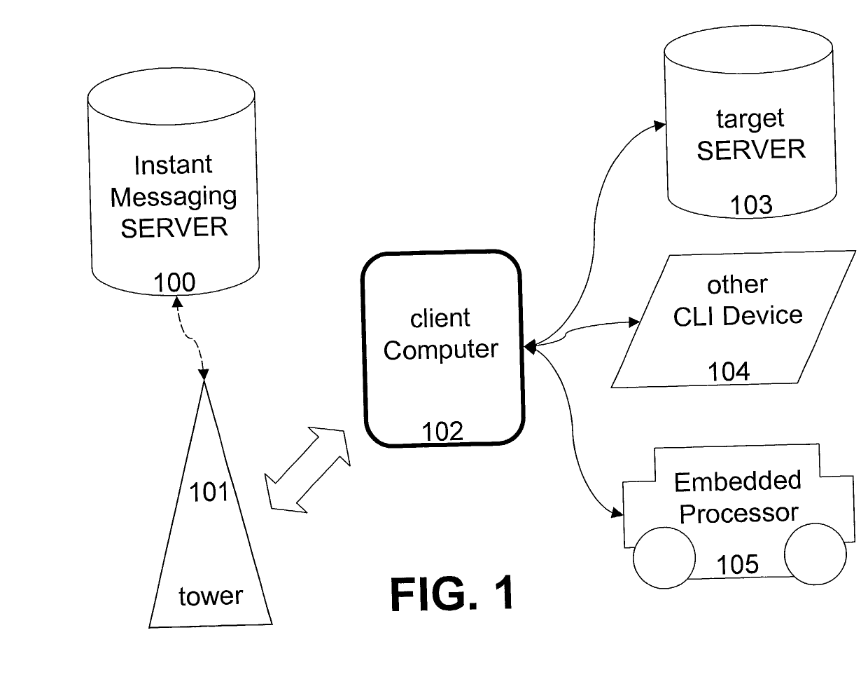

Referring to FIG. 1, an embodiment of the invention showing a wired configuration. The client Computer 102 must first make a physical connection (represented with solid line) to the target Device. The Device could be a server 103, an embedded processor 105, or any device that has a Command Line Interface (CLI) 104. On most Devices this connection will be a cable to the serial port or a COM port of some type. With this physical connection in place, all the functionalities described in these embodiments can be enacted.

If enacted, the Instant Messaging (IM) client should communicate over another connection. Shown here is a wireless connection (represented with a big arrow) to a tower 101 being used to reach through the internet (represented as a dashed line) to the IM server 100. This scenario is likely to be the most common since many uses of the invention are well suited for use with portable devices.

This first variation is for the Computer to run a RC connected directly to the Device. In this formation, the Computer is connected via a physical cable to a serial port on the Device. Once connected, the Client is able to recognize the machine to which it is connected, and also to begin communication, in essence to tell the machine that the client will act as a stand-in monitor and keyboard. This concept is referred to as a “console.”

Once the Device is recognized, the menu and shortcut directories are built to make the interaction with that specific device easier and more efficient. If the Device operates a form of UNiversal IntereXchange (Unix), then the menus come complete with many common Unix commands and special key combinations. This is useful not only for saving time by not having to make so many keystrokes, this feature is very preferable where a large number of commands must be memorized. Even the most experienced may benefit from this feature.

If the Device is somehow recognized incorrectly, or perhaps there is more than one possible setup for a given Device, the user can select his preference of menu system. If desired these menus and shortcuts can be custom defined. In this embodiment, all communication between the Client and the Device is preferably restricted to ASCII characters. This restriction in this embodiment constitutes part of the definition of a console, and it refers both directions of communication.

The default mode for the UI of the Client displays all output received from the Device, and allows access to all menus and shortcuts at the click of a button. Typically a long list of commands, all the shortcuts and drop-down menus are intuitively organized and nested so that a user may come to access them all with ease and familiarity.

The UI can include an optional IM client, which communicates over a separate connection to the Internet. In this way the user can contact other users and they can pass information in a convenient way. If there is no other way for the computer to access the internet, the messenger cannot be used in this variation. Details of the instant messenger will be described later. Notably, the Device should not be able to distinguish between the operation of the invention and that of a typical console.

In one embodiment of the invention, the Device is a typical server. This server can run any operating system (OS) available. Common examples are: Solaris™, Linux™, Berkeley Software Design, Inc. (BSDI™), Silicon Graphics Incorporated (SGI™), Advanced Interactive Executive (AIX™), Windows® NT, Windows(® 2000, and Windows® XP, Neutrino™, BeOS™, Mac™ OSX. The OS of the Computer could similarly be any operating system. Common examples are: Solaris™, Linux™, Windows® NT, Windows® XP, and Mac™ OSX.

To make the user's experience simple and intuitive, once the Client recognizes the hardware and OS of the Server, a series of menus are built which have commands and actions listed, all specific to the Server OS and prom monitor if applicable. Each of these commands is available at the touch of a button. They can be enacted upon selection, or they can merely be printed to the command line for editing or for setting flags.

In another embodiment, the Device is not merely a typical server but is instead any machine that has a CLI port. This embodiment describes a more general definition of the invention. These Devices could include but are not limited to: hubs, routers, switches, bridges, repeaters, gateways, firewalls, interactive television hardware, manufacturing hardware, robotics, and animatronics.

Another embodiment of the invention describes an even more general definition of the invention, where the Device is not merely a typical server, or a machine that has a CLI port, but is simply any embedded processor. This could describe the processor in vending machines, an automobile, medical equipment, cable boxes, security systems, home monitoring systems, entertainment equipment, or even home appliances, to name a few examples. Many of these processors have extremely simple operating systems to which the interface could be merely connecting a diagnostic device to read error codes.

Another embodiment of the invention narrows the specification to the client side use of smaller computers, for example: Handhelds, PDAs, Wireless Application Protocol (WAP) Phones, and Two-way Pagers. The platform that these smaller computers run on could be Palm™ devices, PocketPC™ devices, Handspring™ devices, RIM™ devices, Nokia™ devices, Neopoint™ devices, and similar devices.

Typically, these computers have no access to special keys and are unable to accomplish some or all key combinations. Under these limited conditions it is impossible to emulate the full interaction of a keyboard. Examples of special keys are the control key, “Ctrl,” the escape or Meta key, “Esc,” and all function keys, “F1-F12.” Examples of commonly used combinations are, “Ctrl+x+s,” and “Esc+Shift+5.” These are clearly difficult to enter without a full keyboard. The invention overcomes this limitation by supplying all needed special keys and combinations via nested intuitive menus or drop-down lists.

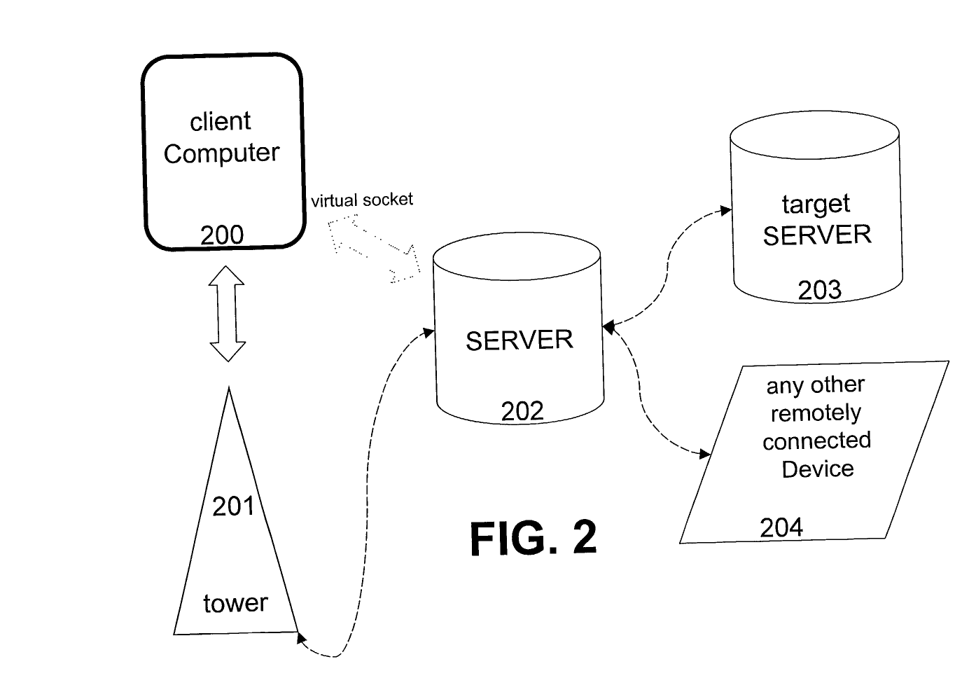

Referring to FIG. 2, a wireless configuration of an embodiment is shown. The client Computer 200 is attempting to open up a telnet or similar session with either the target server 203 or another Device 204. A Network Virtual Terminal Protocol (telnet) or similar connection between the Server 202 and either target is uncomplicated, but to extend the telnet session to the client 200 requires something analogous to “sockets” used in the programming languages C++ language and Java™ language. Since communication between the client 200 and the server 202 typically must go through a wireless network and gateway and then the internet, special software is used at 202 and at 200 to create a “virtual socket.” This concept merely refers to an input/output (J/O) structure that behaves similar to a typical socket even though its underlying transport layer is atypical and inhomogeneous. The telnet or telnet-like session is opened and closed by the Server 202. The client 200 is merely a display and input device. From there, however, the user has full proxy control over the session. If instant messaging is desired in this configuration, the IM server can be hosted on the Server 202.

Another variation is for the Computer to run a RC communicating with the Device via a wireless connection. In this formation, the Computer opens communication with the Device through its wireless connection and through an intermediary server that will be referred to here as the “Server.” Once the Computer is connected to the Device the client software is able to recognize the machine to which it is connected, and also to begin communication.

The actual mechanics of the communication between the Computer and the intermediary server can be briefly described by the following: the most common situation is one where the wireless modem on the Computer connects through a cell tower to a gateway which the carrier uses to interface the wireless network with the internet. From there the wireless device can get access to the rest of the internet, including the intermediary Server. Once connected, the Server and the Client can open what is referred to as a “virtual socket.” This connection is the packet switched analogy of a typical socket as it would be used in C++ or Java.

As in the first variation, once the Device is recognized, the menu and shortcut directories are built for that specific device. If the Device is somehow recognized incorrectly, or perhaps there is more than one possible setup for a given Device, the user can select his preference of menu system. If desired these menus and shortcuts can be customized. Typically, all communication between the Client and the Device is restricted to ASCII characters. This restriction constitutes part of the definition of a console, and it refers both directions of communication.

The default mode for the UI of the Client displays all output received from the Device, and allows access to all menus and shortcuts at the click of a button. Typically a long list of commands, all the shortcuts and drop-down menus are intuitively organized and nested so that a user may come to access them all with ease and familiarity.

The UI can include an optional instant messaging client that communicates over the same wireless connection to the internet In this way the user can contact other users and they can pass information in a convenient way. Details of the instant messenger will be described later. Notably, the Device should not be able to distinguish between the operation of the invention and that of a typical console.

In one embodiment of this variation of the invention, the Device is a typical server. This server can run any OS available such as the ones previously listed. As in the previous variation, the Client recognizes the hardware and OS of the Server, and then builds a series of menus and/or drop-down lists that include appropriate commands and actions, all specific to the Server OS and prom monitor if applicable. Each of these commands is available at the touch of a button. They can be enacted upon selection, or they can merely be printed to the command line for editing or for setting flags.

In another embodiment of this variation, the Device is not merely a typical server but is instead any machine that can make a remote or networked connection. Some of these Devices could include hubs, routers, switches, bridges, repeaters, gateways, firewalls, interactive television hardware, manufacturing hardware, robotics, animatronics, vending machines, an automobile, medical equipment, cable boxes, security systems, home monitoring systems, entertainment equipment, or even home appliances, to name a few examples. In some cases the CLI will be a standard form, such as telnet, secured shell (ssh), ssh2, ssh3, or file transfer protocol (ftp), and other times the it will be a proprietary form. The client could even connect to a corporate server and function as a part of a Virtual Private Network (VPN).

Another embodiment of this variation of the invention narrows the specification to the client side use of smaller computers, for example: Handhelds, PDA's, WAP Phones, and Two-way Pagers. The platform that these smaller computers run on could be any of the platforms previously described herein. As before, these computers have no access to special keys and are unable to accomplish some or all key combinations, making it very difficult to emulate the full interaction of a keyboard. The invention overcomes this limitation by supplying all needed special keys and combinations via nested intuitive menus or drop-down lists

Another embodiment of the invention provides for Terminal Emulation via a COM port. The Computer runs a Terminal Emulator connected directly to the Device using a configuration such as the one depicted in FIG. 1. In this formation, the Computer is connected via a physical cable to a serial port on the Device. Once connected, the Client is able to recognize the machine to which it is connected and to communicate is a more robust form than a console. Besides ASCII characters, this variation is able to use the entire ANSI terminal set of escape sequences to communicate special functions and display capabilities. This concept is referred to as a “terminal.”

Once the Device is recognized, the menu and shortcut directories are built. As with other variations of the invention, the user can select his preference of menu system. If desired these menus and shortcuts can be custom defined. As in the first variation, all communication between the Client and the Device is restricted to ASCII characters. The Client displays all output received from the Device, and allows access to all menus and shortcuts at the click of a button.

The UI can include an optional instant messaging client that communicates over a separate connection to the internet. If there is no other way for the computer to access the internet, the messenger cannot be used in this variation. Notably, the Device should not be able to distinguish between the operation of the invention and that of a typical terminal.

In one embodiment of this variation of the invention, the Device is a typical server on any of the platforms mentioned in the first embodiment discussed above. In another embodiment, the Device is any machine that has a CLI port. In vet another embodiment, the Device is any embedded processor, as described in the first variation. Moreover, the client side hardware may be a smaller computer, such as a Handheld, PDA, WAP Phone, or Two-way Pager on any platform as described above. The invention overcomes the limited interface by supplying all needed special keys and combinations via nested intuitive menus or drop-down lists.

A useful benefit of the full functioning terminal over the console is that it can run common file editors such as vi and emacs. These programs use escape sequences to enact control over the display of the Computer and therefore will not function on a console.

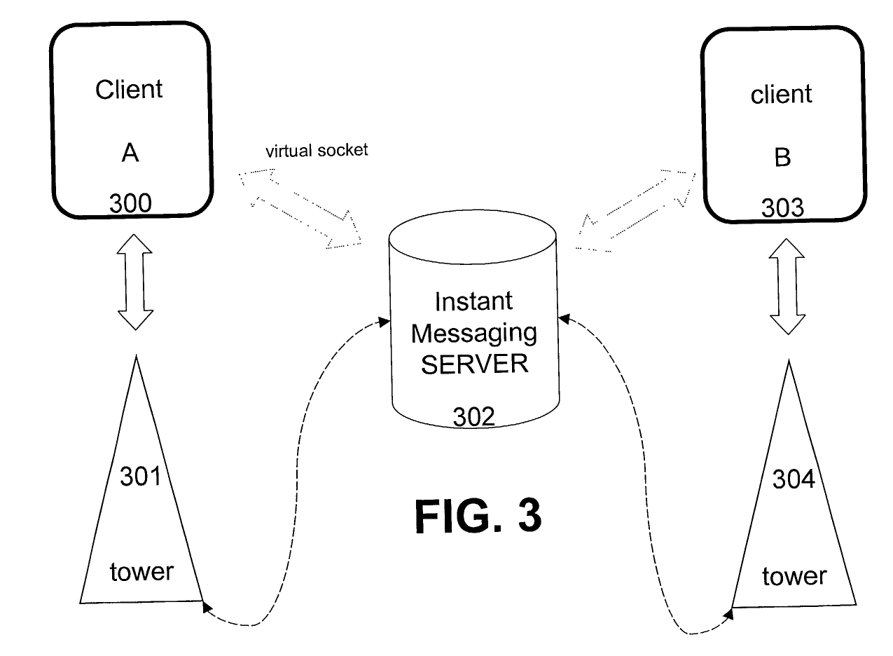

Referring to FIG. 3, Instant Messaging is shown in conjunction with the invention. Two clients 300 and 303 may or may not be near the same tower. One initiates a dialogue with the other. This initiation hits the tower and goes through a network to the Server 302 that hosts the IM server and may or may not host other server components of the invention. The Server 302 then initiates the dialogue with the target party on the part of the initiator. Upon finding both parties, virtual sockets are opened between each party and the IM Server, which from that point on acts as an intermediary between the two, and will notify either party if a third client initiates contact with either one or both. Multi-user messaging, or “chat” is also possible. It is merely a different choice on the same drop-down list for the user.

In one embodiment of the invention, there are instant messaging capabilities included in the invention similar to those of the industry standard. There are two components, a server piece and clients. Specific functionalities of the server include the ability to maintain multiple sessions between multiple users simultaneously.

Specific functions of the Client include the ability to open up two way instant communication with another Client, the persistence in local memory of each dialogue, and the ability to switch between each dialogue. The UI of the client has a drop-down list with the usernames of other clients to which it can connect. Selecting a user in the list initiates the display of past dialogue with that user. The connection with that user is opened when their username is selected in another client. A pop-up window on the target client will give notification to that user that communication is requested, and by whom.

For all embodiments of the second variation shown in FIG. 2 described above, there is a very preferable component referred to as the intermediary server referred to as “Server.” This component is optional for other variations as it would only be used for instant messaging in those cases. The purpose of the Server is to act as an intermediary between the Client and the Device, to act as the instant messaging server.

The Server hosts a database of settings. These settings contain information about each user: their usemames, passwords, etc. This database also contains information about each Device to which the users want to connect: IP addresses, logins, etc.

In these embodiments, all wireless activities can be made secure in multiple ways. As the user logs on he can be prompted for a password. As any connection is spawned, the Server can request the hardware ID of the Computer. This security can include both connections to a Device and to other IM clients.

In another embodiment of the invention, there is yet another Server component called a monitoring server which can be but is not necessarily run on the same machine as the Server component described above. This component can ping other Devices and generally monitor any statistics required about them. For a given Device, this Server can monitor many parameters: server status, email server status, virtual machine status, number of open connections, source and clearance of each connected user, error codes, and network congestion, to name a few.

This Server provides a User Interface through which a user can set alarms and thresholds such that upon the sensing of a specified level of trouble in a given system, the Server will contact the user either by instant message, email, or some other method. All these settings and thresholds can be modified or created in the UI. Through this UI a user can retrieve an instant update of all monitored statistics. When problems do arise, the data can be passed to a troubleshooting program which may help diagnose the issue, or would allow the user to access Frequently Asked Questions (FAQs) or other sources of online assistance.

The actual nested menu organization may vary considerably from the embodiments shown herein. The following table provides a preferred embodiment of the invention coded for a target Device running the Solaris™ 8 operating system. The top-level commands, or those in “Menu Level 1,” are the first visible upon opening the menu system. The different colored vertical bands mark show to which Menu Level a listed command pertains. When a menu option has a submenu, this option is denoted in the diagram by “>”. A box containing the entire submenu also borders these submenus.

TABLE 1
Menu Layout for Solaris ™ 8 operating system

| Menu level 1 | Menu level 2 | Menu level 3 | Menu level 4 |
|---|---|---|---|
| Hide Menu | Hide Menu | | |
| Close | Close | | |
| > Device Settings | Hide Menu | | |
| | Connection Information | | |
| | > Default | Default(9600-8bit) | |
| | | Setting 1 (9600-7bit) | |
| | | Setting 2 (38400E) | |
| | > Baud Rate | 115200 | |
| | | 76800 | |
| | | 57600 | |
| | | 38400 | |
| | | 19200 | |
| | | 9600 | |
| | | 4800 | |
| | | 2400 | |
| | | 1200 | |
| | | 300 | |
| | > Parity | NONE | |
| | | EVEN | |
| | | ODD | |
| | > Data Bits | 5 | |
| | | 6 | |
| | | 7 | |
| | | 8 | |
| | > Stop Bits | 1 | |
| | | 2 | |
| > Special Keys | ESC | | |
| | X-ON | | |
| | X-OFF | | |
| | > CTRL+ | c | |
| | | u | |
| | | s | |
| | | q | |
| | | d | |
| | | z | |
| | | w | |
| | | > A-H | a |
| | | | b |
| | | | c |
| | | | d |
| | | | e |
| | | | f |
| | | | g |
| | | | h |
| | | > I-P | i |
| | | | j |
| | | | k |
| | | | l |
| | | | m |
| | | | n |
| | | | o |
| | | | p |
| | | > Q-Z | q |
| | | | r |
| | | | S |
| | | | t |
| | | | u |
| | | | v |
| | | | w |
| | | | x |
| | | | y |
| | | | z |
| | STOP-A | | |
| | F1/ESC_1 | | |
| | F2/ESC_2 | | |
| | F3/ESC_3 | | |
| | F4/ESC_4 | | |
| | F5/ESC_5 | | |
| | F6/ESC_6 | | |
| | F7/ESC_7 | | |
| | F8/ESC_8 | | |
| | F9/ESC_9 | | |
| | F10/ESC_10 | | |
| | F11/L1 | | |
| | F12/L2 | | |
| Console | >Configs | Hide Menu | |
| | | >Network | ifconfig |
| | | | ifconfig -a |
| | | | netstat |
| | | | netstat -rn |
| | | | netstat -vat |
| | | >OS | pkginfo |
| | | | pkginfo -p |
| | | | swap -1 |
| | | | swap -a |
| | | | swap -d |
| | | | uname -a |
| | | | vmstat 5 |
| | | | tail -f |
| | | | /var/adm/messages |
| | | >Processes | ps |
| | | | ps -aef |
| | | | ps -aefw |
| | | | ps -aef\|grep |
| | >Processes | Hide Menu | |
| | | kill | |
| | | kill -9 | |
| | | pkill | |
| | >Terminal | Hide menu | |
| | | stty | |
| | | stty -a | |
| | | stty 9600 | |
| | | stty 11520 | |
| | >System | | |
| | | Hide Menu | |
| | | halt | |
| | | reboot | |
| | | shutdown | |
| | | shutdown -y -g0 | |
| | | sync | |
| | >File System | Hide Menu | |
| | | ls | |
| | | ls -f | |
| | | ls -a | |
| | | cd .. | |
| | | cd / | |
| | | cd /etc | |
| | | cd /usr | |
| | | cd /var | |
| | | cd /var/adm | |
| | | dirs | |
| | | pushd | |
| | | popd | |
| | | pwd | |
| | Go to Highlighted | | |
| | Directory | | |
| | Top of Page | | |
| | Bottom of Page | | |
| | Command History | | |
| | Send break | | |
| > PROM Monitor | Hide Menu | | |
| | stop-a | | |
| | printenv | | |
| | reboot from CDROM | | |
| | > boot | boot | |
| | | boot -r | |
| | | boot -s | |
| | > probe | probe-scsi | |
| | | probe-scsi-all | |
| | > setenv | setenv | |
| | | setenv diag-switch? | |
| | | true | |
| | | setenv diag-level | |
| | | setenv auto-boot? | |
| | | setenv boot-device | |
| | Special Keys | | |
| | Top of Page | | |
| | Bottom of Page | | |
| | Command History | | |
| | Send Break | | |

The disclosed invention in its various embodiments addresses the issues of efficiency and facility with respect to the field of maintenance of servers, embedded systems, and any device with a Command Line Interface. It is important to understand that any of the disclosed embodiments may function in parallel with one another in order to fulfill different uses.

Various basics of the invention have been explained herein. The various techniques and devices disclosed represent a portion of that which those skilled in the art would readily understand from the teachings of this application. Details for the implementation thereof can be added by those with ordinary skill in the art. Such details may be added to the disclosure in another application based on this provisional application and it is believed that the inclusion of such details does not add new subject matter to the application. The accompanying figures may contain additional information not specifically discussed in the text and such information may be described in a later application without adding new subject matter. Additionally, various combinations and permutations of all elements or applications can be created and presented. All can be done to optimize performance in a specific application.

What is claimed is:

1. A method for using a computer to emulate a remote console for connection to a target device, wherein the computer has an output screen and wherein the target device has a serial port and a target device platform, the method which comprises the steps of:
(a) opening a connection through a wire to the serial port on the target device;
(b) automatically recognizing the target device platform;
(c) building menus, drop-down lists, or shortcuts according to the target device;
(d) entering commands on the computer;
(e) entering commands on the computer via the menus or the shortcuts;
(f) sending commands to the target device via the serial port;
(g) receiving output from the target device;
(h) displaying the output on the output screen; and
(i) running an instant messaging client in parallel;
wherein the target device does not distinguish the computer from a remote console.

2. The method of claim 1 wherein the target device is a server.

3. The method of claim 1 wherein the target device comprises a command line interface port.

4. The method of claim 1 wherein the target device is an embedded system.

5. The method of claim 1 wherein the computer is a handheld computer.

6. The method of claim 1 wherein the commands are in ASCII format and the output is in ASCII format.

7. The method of claim 1 wherein the remote console is a full function terminal and wherein the commands in ANSI format and the output is in ANSI format.

8. The method of claim 7 wherein the target device comprises a command line interface port and the command line interface is selected from the group consisting of DOS prompt, korn shell, sh, bash, tcsh, prom monitor, VT100.

9. The method of claim 7 which further comprises the step of enabling full functioning of standard terminal editors such as vi and emacs.

10. A computer for emulating a remote console for connection to a target device, wherein the target device has a serial port and a target device platform, the computer comprising
an output screen;
a connector capable of connecting through a wire to the serial port on the target device;
menus, drop-down lists, or shortcuts according to the target device; and
an instant messaging client;
wherein the computer is capable of: automatically recognizing the target device platform; receiving entered commands; receiving entered commands via the menus or the shortcuts; sending commands to the target device via the serial port; receiving output from the target device; displaying the output on the output screen; running the instant messaging client in parallel; and
wherein the target device is not capable of distinguishing the computer from the remote console.

11. The computer of claim 10 wherein the target device is a server.

12. The computer of claim 10 wherein the target device comprises a command line interface port.

13. The computer of claim 10 wherein the target device is an embedded system.

14. The computer of claim 13 wherein the embedded system is a vending machine, an automobile, medical equipment, a cable box, a security system, a home monitoring system, an entertainment equipment, or a home appliance.

15. The computer of claim 10 wherein the commands are in ASCII format and the output is in ASCII format.

16. The computer of claim 10 wherein the remote console is a full function terminal and wherein the commands are in ANSI format and the output is in ANSI format.

17. The computer of claim 10 which further comprises a full functioning of standard terminal editor such as vi and emacs.

18. A method for using a computer to emulate a remote console for connection via a server to a target device, wherein the computer has an output screen and a wireless modem and wherein the target device has a serial port and a target device platform, the method which comprises the steps of:
(a) opening a virtual socket to the server through the wireless modem;
(b) opening a connection between the server and the target device;
(c) automatically recognizing the target device platform;
(d) building menus, drop-down lists, or shortcuts according to the target device;
(e) entering commands on the computer;
(f) entering commands on the computer via the menus or the shortcuts;
(g) transporting the commands to the target device via virtual socket and the server;
(h) receiving output from the device via the virtual socket and the server;
(i) displaying the output on the screen of the computer; and
(j) running an instant messaging client in parallel;
wherein the target device does not distinguish the computer from a remote console.

19. The method of claim 18 wherein Step (b) uses a telnet, secured shell ssh, ssh2, or ssh3, or file transfer protocol.

20. The method of claim 18 wherein the computer is part of a virtual private network.

21. The method of claim 18 wherein the commands are Unix, OS, or prom monitor commands.

22. A computer for emulating a remote console for connection via a server to a target device, wherein the target device has a serial port and a target device platform, the computer comprising
an output screen;
a wireless modem;
a connector capable of opening a virtual socket to the server through the wireless modem and allowing a connection between the server and the target device;
menus, drop-down lists, or shortcuts according to the target device; and
an instant messaging client;
wherein the computer is capable of: automatically recognizing the target device platform; receiving entered commands; receiving entered commands via the menus or the shortcuts; sending commands to the target device via virtual socket and the server; receiving output from the target device via the virtual socket and the server; displaying the output on the output screen; running the instant messaging client in parallel; and
wherein the target device is not capable of distinguishing the computer from the remote console.

23. The computer of claim 22 the target device comprises a hub, a router, a switch, a bridge, a repeater, a gateway, a firewall, interactive television hardware, a manufacturing hardware, a robotics, or an animatronics.

24. The computer of claim 22 wherein the computer is a handheld computer.

25. A method of providing a server system capable of connecting to computer emulating remote consoles for connection to target devices, the method which comprises the steps of:
(a) hosting a database of settings, wherein settings comprises alarm thresholds and preferences regarding monitoring, connection, or messaging;
(b) providing each connected computer with a user interface to modify settings;
(c) enforcing security on all activities by passwords, certificates, or hardware identification;
(d) pinging any targeted device;
(e) monitoring all targeted devices according to a specification or service level agreement;
(f) monitoring network congestion;
(g) providing an instant update on all monitored systems and/or network congestion upon request;
(h) firing alarms when a parameter reaches an adjustable threshold;
(i) diagnosing target device problems and inefficiencies;
(j) hosting interactive troubleshooting programs along with Frequently Asked Questions and Online Help applications; and
(k) running an instant messaging server in parallel to other processes;
wherein the server is capable of maintaining and initiating multiple connections.

26. The method of claim 25 wherein the computers are emulating different types of remote consoles and the system can process in parallel.
